(19) United States
(12) Patent Application Publication
(10) Pub. No.: US 2008/0254810 A1
(43) Pub. Date: Oct. 16, 2008

(54) Methods and Apparatus for Location Determination In A Wireless Communication Device

(76) Inventors: Kenny Fok, San Diego, CA (US); Jagatpreet Singh, San Diego, CA (US); Jihyun Hwang, San Diego, CA (US)

Correspondence Address: QUALCOMM INCORPORATED, 5775 MOREHOUSE DR., SAN DIEGO, CA, 92121, US

(21) Appl. No.: 11/734,633

(22) Filed: Apr. 12, 2007

Related U.S. Application Data
(60) Provisional application No. 60/868,690, filed on Dec. 5, 2006.

(51) Int. Cl. H04Q 7/20

(52) U.S. Cl. 455/456.2

(57) ABSTRACT

Methods, systems, devices and computer program products are presented for identifying a location determination mode based on execution of a mode-selection routine in response to a received location determination request. In certain aspects, identifying a location determination mode may involve sequencing through a plurality of modes until a successful location determination results or until the end of the sequence is reached. In other aspects, selecting a location determination mode may involve determining one or more conditions affecting a location determination mode, and identifying an available mode based on the determined conditions. In this regard, according to some aspects, location determination is performed dynamically in that selection of a location determination mode is carried out for each location request and may take into account current conditions affecting one or more location determination modes.

### CLAIM OF PRIORITY UNDER 35 U.S.C. §119

The present Application for Patent claims priority to Provisional Application No. 60/868,690 entitled “Method And Apparatus For Switching Between Operation Modes For Increasing GPS Yields” filed Dec. 5, 2006, and assigned to the assignee hereof and hereby expressly incorporated by reference herein.

### BACKGROUND

1. Field

The disclosed aspects relate to wireless communication devices, and more particularly, to systems, methods and apparatus that provide for location determination in wireless communication devices

2. Background

Wireless communication devices, such as cellular telephones, portable computers and the like, have rapidly gained in popularity over the past decade. These devices are increasingly becoming multifaceted devices capable of providing a wide-range of functions. For example, today's cellular telephone may also embody computing capabilities, Internet access, electronic mail, text messaging, GPS mapping, digital photographic capability, an audio/MP3 player, video gaming capabilities, video broadcast reception capabilities and the like.

In addition to the myriad of functions listed, a mobile communication device may be equipped with a location determination service, such as a Global Positioning System (GPS) based module and/or a communication network-based module, which allows the device to determine its position, such as a geographic position and/or a network position, at any point in time. For example, position or location information is used in navigation systems, which track geographic position with respect to a mapped destination, and such systems may be incorporated within a wireless communication device, such as cellular telephones or the like. However, use of position information in wireless communication devices is not limited to navigation systems. Other applications may also utilize location information. For example, performance tracking systems, which may reside internally at the wireless device or externally at the network level, benefit from knowing the location at which a performance event occurs, such as the location of a call drop, an out of service (OOS) occurrence, a call failure, and/or an access success. Additionally, many other applications utilize environmental characteristics of the device, including the location of the device, to modify or update the methodology of the application.

Currently, various modes of operation exist for determining location. For example, GPS systems may rely on a Mobile Station-Based (MS-Based) mode, a Mobile Station-Assisted (MS-Assisted) mode, a Standalone mode or any other feasible mode currently known or known in the future. The various modes offer different methods for determining location.

For example, in MS-Based mode the wireless device obtains information related to the location of GPS satellites from a network Position Determining Entity (PDE) and then performs the location determination calculation at the wireless communication device. The satellite location information is commonly referred to as Ephemeris data and Almanac data. Almanac data is course orbital parameters for all the GPS satellites in the system and is considered valid for up to several months. Ephemeris data by comparison is very precise orbital and clock correction for each GPS satellite and is considered valid for only about 30 minutes. Thus, in MS-Based mode, a wireless device may, but is not always required to, obtain the information from the PDE depending on the currentness or age of the satellite information.

In MS-Assisted mode, the wireless device exchanges information, such as satellite communication information and/or base station information and/or network-based information related to location with the PDE, and further receives the calculated location from PDE. As such, in order for the MS-assisted mode to operate, the wireless device needs to be in communication with the PDE. Therefore, by comparison, while MS-based mode utilizes a wireless signal to communicate with the PDE for some of the location determinations, MS-assisted mode utilizes a wireless signal to communicate with the PDE for all location determinations.

In contrast, in Standalone mode, all the location determination functions are carried out at the wireless device. As such, Standalone mode does not utilize a wireless communication signal to communicate with the PDE to determine the location. In Standalone mode, however, the wireless device utilizes signals from at least three GPS satellites to determine its position. Thus Standalone mode has a high failure rate when attempts are made indoors as satellite signals are weak or cannot be received, while the MS-Assisted mode is typically the mode of preference when attempts are made indoors as communication network signals can often still be exchanged between the wireless device and the wireless network.

In current practice, the applicable GPS mode is defined by the application or is chosen at the initialization/start-up stage of the wireless device, which is a methodology that is oblivious to conditions experienced by the wireless device that may affect the likelihood of success of determining a location. As such, the chosen mode applies to location determination requests even if the chosen mode may not be the best mode for the given scenario. For instance, various conditions may exist throughout the executing duration of an application that are relevant to the effectiveness of the chosen mode. For example, MS-Assisted mode utilizes a wireless communication signal, such as a CDMA (Code Division Multiple Access) signal or GSM (Global System for Mobile) signal or UMTS (Universal Mobile Telephone System) signal, and, therefore, if the chosen mode is MS-Assisted, location determination will not be successful if the wireless signal is not active or if a call cannot be established and maintained. Other conditions that affect the performance of location determination modes are the current environment of the device, battery charge level, voice call state, data call state, the currentness or age of the PDE satellite information and the like.

Therefore, a need exists to overcome location determination failure rates attributable to choosing the location determination mode at the application level or at initialization stage of the wireless device. The desired methods and apparatus should take into account conditions that exist at the point in time when a location determination is made to insure the likelihood of the location determination being successful.

### SUMMARY

Present aspects provide for methods, devices, systems and computer program products for improving location determination in a wireless communication device. Specifically, present aspects provide for identifying a location determination mode in response to a location determination request and based on a mode-selection routine. In this regard, present aspects provide greater flexibility in the selection of the location determination mode and, as such, result in a significant decrease in location determination failure rate.

In certain aspects, identifying and attempting a location determination mode may involve executing a predetermined sequence of location determination modes, where each one of the sequences is referred to as a trial. Further, in some aspects, each trial may be attempted a predetermined number times until a successful location determination results or until the predetermined number is reached. In other aspects, identifying a location mode may involve selecting from among multiple location determination modes. Further, in some aspects, identifying may involve determining one or more conditions affecting one or more location determination modes, listing and/or prioritizing the modes based on the determined existing conditions, and selecting an available mode based on the conditions. In this regard, according to some aspects, location determination is performed dynamically in that selection of a location determination mode is carried out for each location request and may take into account current conditions affecting the modes.

In one aspect, a method for location determination in a wireless communication device is defined. The method includes receiving a request for a location of the wireless communication device, identifying a location determination mode based on execution of a mode-selection routine in response to the received request, attempting to obtain the location of the wireless communication device based on the identified location determination mode, and storing the result of the attempt to obtain location of the wireless communication device in memory. In some aspects, the request for a location may come from an application executable on the wireless device, while in other aspects the request may come from a network entity that is in wireless communication with the device. The location determination mode may include a GPS-based mode and/or a network-based mode. Examples of GPS-based location determination modes include, but are not limited to Mobile Station-Based mode (MS-Based mode), Mobile Station-Assisted mode (MS-Assisted mode), Standalone Mode and any other currently known or future known location determination mode. Additionally, examples of communication network-based location determination modes include cell identification, enhanced cell identification, time of arrival, angle of arrival, enhanced observed time difference (E-OTD), cell broadcast, cell-based position, and Advanced Forward Link Trilateration (AFLT).

According to the method, identifying a location determination mode may provide for sequencing through a plurality of location determination modes and executing a predetermined number of location determination attempts for each mode until a location of the wireless communication device is determined or until the predetermined number is reached. In other aspects of the method, identifying a location determination mode may provide for determining one or more existing conditions affecting a location determination mode, and identifying an available mode based on the existing conditions. Examples of existing conditions include, but are not limited to, current wireless signal state, such as Code Division Multiple Access (CDMA) signal state or Global System for Mobile (GSM) communications signal state, Universal Mobile Telecommunications System (UMTS) signal state, Wireless Fidelity (Wi-Fi) signal state, Worldwide Interoperability for Microwave Access (WiMAX) signal state, current state of assistance information communicated from the PDE, such as ephemeris data, almanac data and the like, current communications state, such as voice call state, data session state or the like, current battery power state, current environmental condition(s) state, such as visibility or received signal strength of GPS satellites, and any other existing conditions which may affect location determination.

A further related aspect of the invention is defined by at least one processor for determining location. The processor includes a first module for receiving a request for a location of the wireless communication device, a second module for identifying a location determination mode based on execution of a mode-selection routine in response to the received request, a third module for attempting to obtain the location of the wireless communication device based on the identified location determination mode and a fourth module for storing the results of the attempt to obtain location of the wireless communication device in memory.

Another related aspect is provided for by a computer program product. The computer program product includes a computer-readable medium having a first set of codes for causing a computer to receive a request for a location of the wireless communication device, a second set of codes for causing a computer to identify a location determination mode based on execution of a mode-selection routine in response to the received request, a third set of codes for causing a computer to attempt to obtain the location of the wireless communication device based on the selected location determination mode and a fourth set of codes for causing the computer to store the results of the attempt to obtain location of the wireless communication device in memory.

Yet another aspect is defined by a wireless communication device. The device includes means for receiving a request for a location of the wireless communication device, means for identifying a location determination mode based on a mode-selection routine, means for attempting to obtain the location of the wireless communication device based on the selected location determination mode and means for storing the results of the attempt to obtain location of the wireless communication device in memory.

A further aspect is provided for by another wireless communication device. The device includes a computer platform including a processor and a memory and a location determination module stored in the memory, executable by the processor, and including a mode-selection routine operable to identify a location determination mode based on a received request for a location of the wireless device. The location determination module is further operable to attempt to obtain the location based on the identified location determination mode and store the results of the attempt in the memory. In some aspect, the identified location determination mode may be selected from a plurality of modes that may include, but are not limited to, MS-Based mode, MS-Assisted mode, Standalone mode, and communication network-based modes. The location determination module may be operable to receive location requests from applications executable on the wireless device and/or from network entities that are in wireless communication with the wireless device.

The mode-selection routine of the location determination module may be operable to sequence through a plurality of location determination modes and attempt a predetermined number of location determination attempts for each mode trial until a location of the wireless communication device is determined or until the sequence is exhausted. Alternatively, the mode-selection routine may be operable to determine one or more existing conditions affecting a location determination mode and select an available mode based on the existing conditions. The conditions that affect location determination modes may include, but are not limited to, current wireless signal state, such as Code Division Multiple Access (CDMA) signal state or Global System for Mobile (GSM) communications signal state, Universal Mobile Telecommunications System (UMTS) signal state, Wireless Fidelity (Wi-Fi) signal state, Worldwide Interoperability for Microwave Access (WiMAX) signal state, current state of information communicated from the PDE, such as ephemeris data, almanac data and the like, current communications state, such as voice call state, data session state or the like, current battery power state, current environmental condition(s) state, such as visibility or received signal strength of the GPS satellites, and any other existing conditions which may affect location determination.

Thus, present aspects provide for methods, systems, devices and computer program products that improve the ability of the wireless device to determine location. Present aspects provide for identifying a location determination mode based on a mode-selection routine for each location determination that is requested. In this regard, present aspects provide greater flexibility in the selection of the location determination mode, do not limit the mode selection to an application-basis or an application initialization-basis and, as such, present aspects significantly decrease location determination failure rates in wireless communication devices.

### BRIEF DESCRIPTION OF THE DRAWINGS

The disclosed aspects will hereinafter be described in conjunction with the appended drawings, provided to illustrate and not to limit the disclosed aspects, wherein like designations denote the elements, and in which:

FIG. 1 is a block diagram of a wireless communication device operable for selecting a location determination mode to determine a device location based on a mode-selection routine, according to an aspect;

FIG. 2 is a block diagram of a wireless communication device operable for selecting a location determination mode to determine a device location based on a mode-selection routine, according to an aspect;

FIG. 3 is a flow diagram of a method for location determination in a wireless communication device, according to another aspect;

FIG. 4 is a flow diagram of a method for location determination in a wireless device that provides for sequencing through a plurality of modes to determine a location, according to an aspect;

FIG. 5 is a flow diagram of a method for location determination in a wireless device that provides for determining one or more conditions affecting available location determination modes and selecting an available mode based on the existing conditions, according to an aspect;

FIG. 6 is a flow diagram illustrating a specific method for location determination in a wireless communication device; according to an aspect;

FIG. 7 is a detailed flow diagram illustrating a specific method for location determination in a wireless communication device, according to an aspect.

### DETAILED DESCRIPTION

The present devices, apparatus, methods, computer program products and processors now will be described more fully hereinafter with reference to the accompanying drawings, in which aspects of the invention are shown. These aspects may be embodied in many different forms, however, and the invention should not be construed as limited to the aspects set forth herein; rather, these aspects are provided so that this disclosure will be thorough and complete, and will fully convey the scope of the invention to those skilled in the art. Additionally, throughout this description, like numbers refer to like elements.

The various aspects are described herein are in connection with a wireless communication device. A wireless communication device can also be called a subscriber station, a subscriber unit, a mobile station, a mobile, a remote station, an access point, a remote terminal, an access terminal, a user terminal, a user agent, a user device, or user equipment. Further, a subscriber station may be a cellular telephone, a cordless telephone, a Session Initiation Protocol (SIP) phone, a wireless local loop (WLL) station, a personal digital assistant (PDA), a handheld device having wireless connection capability, or any other processing device connected to a wireless modem.

Present aspects provide for systems, methods, devices and computer program products for executing a mode-selection routine to determine a location of the respective wireless device, e.g., a geographic position and/or a network location. Currently various modes exist for determining location, where the modes utilize Global Positioning Systems (GPS) and/or network-based systems for determining location. Examples of such GPS-based modes include, but are not limited to, Mobile Station-Based mode (MS-Based mode), Mobile Station-Assisted (MS-Assisted mode), Standalone mode and the like. Additionally, examples of network-based localization modes include, but are not limited to, cell identification, enhanced cell identification, time of arrival, angle of arrival, enhanced observed time difference (E-OTD), cell broadcast, cell-based position, and Advanced Forward Link Trilateration (AFLT). For instance, such network-based systems utilize timing signals between network nodes, such as base stations and the like, to determine wireless device location. The likelihood also exists that future modes may be developed to make location determination more accurate and efficient. Further, many wireless communication devices are configured to implement more than one location determination mode. Such multi-mode capability may be useful when multiple individual location requesting applications, such as mapping applications, system diagnostic applications and the like, may be configured to request a location using a different mode.

The present aspects provide for the location determination mode to be determined on a per location request basis. In this regard, the mode used to determine location is not static. According to present aspects, each instance of a location request results in the identification of a location determination mode based on a mode-selection routine. In accordance with some present aspects, the mode-selection routine may execute one or more modes in a predetermined sequence until a location is determined or until the sequence is completed. In this case, the execution of a selected mode may be referred to as a trial, and each trial may include a predetermined number of attempts to achieve a successful location determination result. In other aspects, the mode-selection routine may determine one or more existing conditions experienced by the wireless device that affect location determination, and then identify one or more location determination modes based on the existing condition(s). In this case, the one or more identified modes may be in an ordered list, for example, ranked based on some predetermined factor, such a likelihood of success, usage of wireless device resources such as battery power, availability on the given wireless device, etc. Further, in this case, the mode-selection routine may then select and execute at least one of the identified location determination modes in an attempt to determine the device location. In some aspects of this case, the mode-selection routine may execute the selected mode a predetermined number of times before switching to the next identified mode in the ordered list, and so on. Thus, the present aspects provide for a dynamic location determination mechanism.

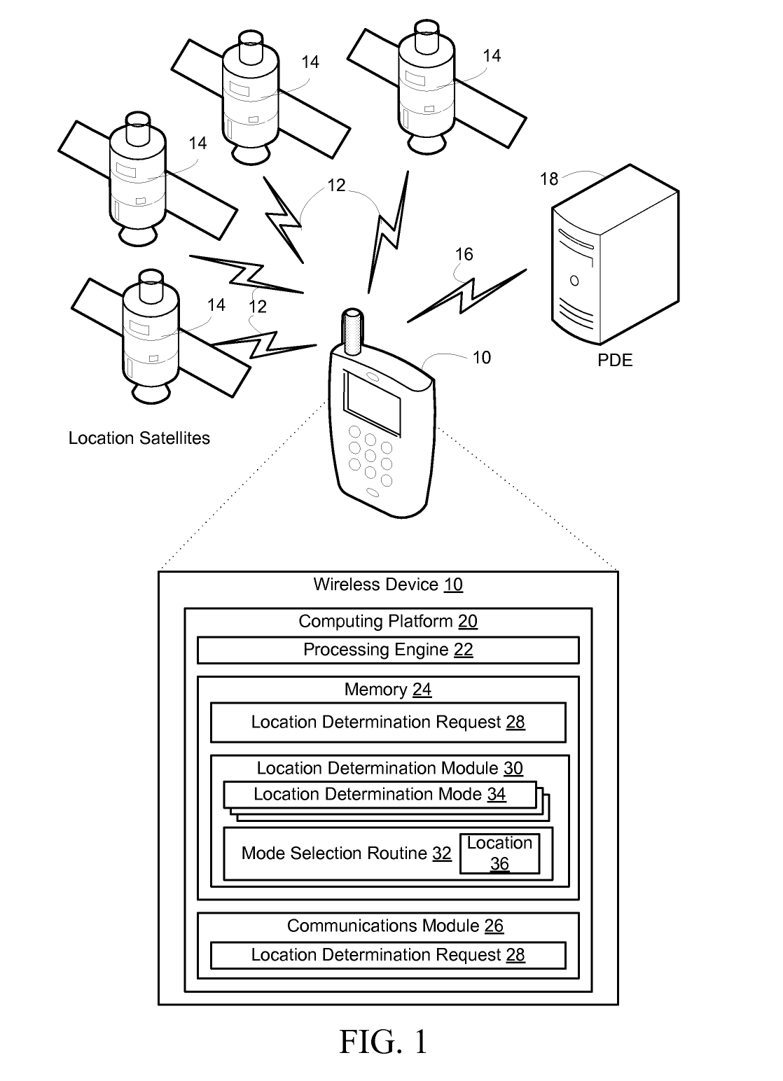

Referring to FIG. 1, a block diagram is depicted of a wireless communication device configured for location determination, according to present aspects. Wireless communication device 10 is operable to determine location based on the identification of at least one location determination mode based on executing a mode-selection routine. As such, wireless communication device 10 is capable of receiving satellite signals 12 from location satellites 14, such as GPS satellites or the like. Received satellite signals 12 are used by the location determination mode to determine the location of the wireless device. In addition, wireless communication device 10 is capable of wireless communication 16, such as via a wireless communication network, with Position Determining Entity 18. In some location determination modes, the PDE provides the wireless communication device with assistance information, such as data used to locate satellites 14, and in some aspects PDE 18 performs the final location calculation and returns the result to the wireless device. In other location determination modes, communication with the PDE is not required.

The wireless communication device 10 includes a computing platform 20 having a processor 22 and a memory 24. Computer platform 20 also includes a communications module 26 operable for transmitting and receiving wireless communication 16 and receiving satellite signals 12. A location determination request 28, commonly referred to as a request for a GPS fix, may originate from one or more applications (not shown in FIG. 1) stored in memory 24 and executable by processor 22. Alternatively, location determination request 28 may be wirelessly received by the communication module 26 from network-based devices (not shown in FIG. 1).

Memory 24 also includes a location determination module 30 that is operable to attempt location determination for the wireless device 10 based on a received location determination request 28. The location determination module 30 includes at least one mode-selection routine 32 that is operable to identify at least one location determination mode 34, for example on a per location request basis. As noted above, location determination modes 34 may include GPS-based and/or network-based modes including, but not limited to, MS-Based mode, MS-Assisted mode, Standalone mode, cell identification, enhanced cell identification, time of arrival, angle of arrival, enhanced observed time difference (E-OTD), cell broadcast, cell-based position, and Advanced Forward Link Trilateration (AFLT). Location determination module 30 identifies one or more location determination modes 34 based on mode-selection routine 32, and then executes at least one selected mode in an attempt to determine location 36. Location 36 may be defined in geographic terms, such as latitude and longitude, and may further include velocity information. Also, location 36 may be defined in network terms, such as by being associated with a network device such as a base station or cell tower, which then indirectly may be associated with a geographic definition. If execution of the respective location determination mode 34 is successful, then location 36 may be stored in memory 24 on wireless device 10, such as for use by an application on the device and/or for forwarding to another device. If execution of the respective location determination mode 34 is not successful, then another mode may be attempted, and/or the location determination process may end without successfully determining location 36. In some aspects, if the execution of location determination mode 34 is not successful, an indicator may be stored in memory 24 indicating that the location determination attempt was not successful.

In some aspects, mode-selection routine 32 may be configured to sequence through multiple trials trying to successfully determine location 36. In addition, mode-selection routine 32 may be configured to provide for multiple attempts within a given trial before the routine abandons the trial and moves to the next trial in the sequence. In other aspects, mode-selection routine 32 may be configured to determine one or more existing conditions experienced by the wireless device that affect location determination, and then identify and/or select for execution a mode based on one or more of the determined existing conditions. Existing conditions are defined as the current status or value of a wireless device condition. Examples of existing conditions include, but are not limited to, current wireless signal state, e.g. existence and/or strength of signal, such as Code Division Multiple Access (CDMA) signal state or Global System for Mobile (GSM) communications signal state, Universal Mobile Telecommunications System (UMTS) signal state, Wireless Fidelity (Wi-Fi) signal state, Worldwide Interoperability for Microwave Access (WiMAX) signal state, current state of GPS assistance information communicated from the PDE, such as ephemeris data, almanac data and the like, current communications services state, such as voice call state, data session state or the like, current battery power state, current environmental condition(s) state, such as visibility or received signal strength of GPS satellites, and any other existing conditions which may affect the execution of one or more location determination modes.

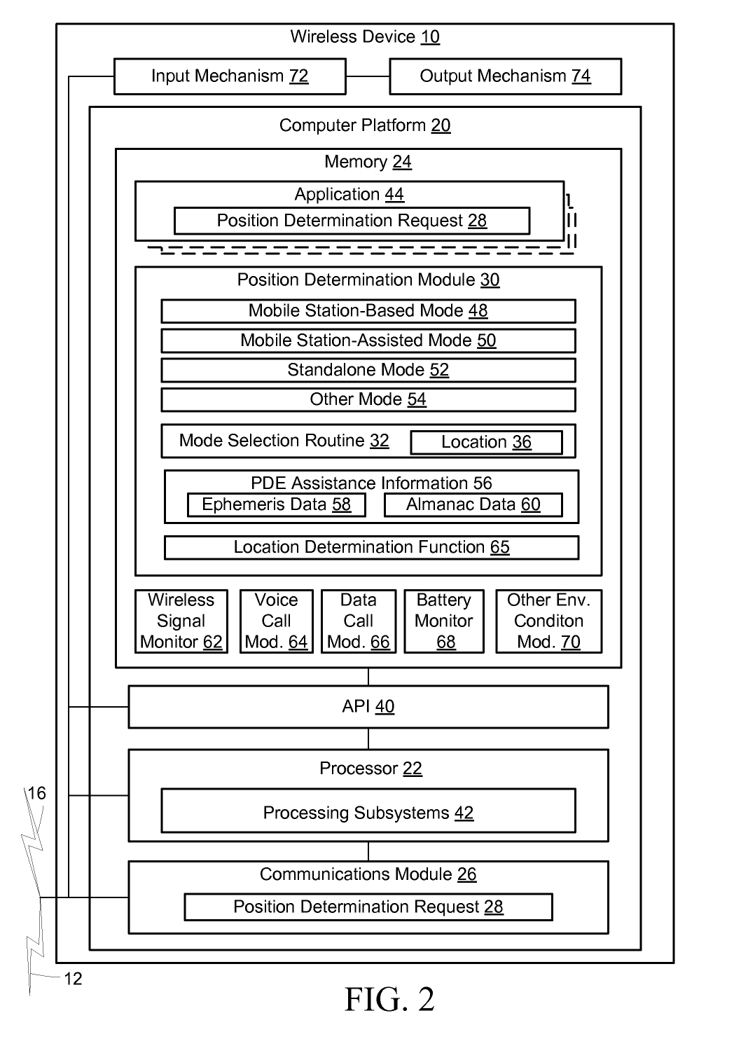

Referring to FIG. 2, according to one aspect, a detailed block diagram representation of wireless communication device 10 is depicted. The wireless communication device 10 may include any type of computerized, communication device, such as cellular telephone, Personal Digital Assistant (PDA), two-way text pager, portable computer, and even a separate computer platform that has a wireless communications portal, and which also may have a wired connection to a network or the Internet. The wireless communication device can be a remote-slave, or other device that does not have an end-user thereof but simply communicates data across the wireless network, such as remote sensors, diagnostic tools, data relays, and the like. The present apparatus and methods can accordingly be performed on any form of wireless communication device or wireless computer module, including a wireless communication portal, including without limitation, wireless modems, PCMCIA cards, access terminals, desktop computers or any combination or sub-combination thereof.

The wireless communication device 10 includes computer platform 20 that can transmit data across a wireless network, and that can receive and execute routines and applications. Computer platform 20 includes memory 24, which may comprise volatile and nonvolatile memory such as read-only and/or random-access memory (RAM and ROM), erasable ROM (EPROM), electronically erasable ROM (EEPROM), flash cards, or any memory common to computer platforms. Further, memory 24 may include one or more flash memory cells, or may be any secondary or tertiary storage device, such as magnetic media, optical media, tape, or soft or hard disk.

Further, computer platform 20 also includes processor 22, which may be an application-specific integrated circuit (“ASIC”), or other chipset, processor, logic circuit, or other data processing device. Processor 22 or other processor such as ASIC may execute an application programming interface (“API”) layer 40 that interfaces with any resident programs, such as location requesting applications 44, location determination module 30 and mode-selection routine 32, stored in the memory 24 of the wireless device 10. However, API 40 is typically not capable of determine which location determination mode to use for a given location determination request. API 40 is typically a runtime environment executing on the respective wireless device. One such runtime environment is Binary Runtime Environment for Wireless® (BREW®) software developed by Qualcomm, Inc., of San Diego, Calif. Other runtime environments may be utilized that, for example, operate to control the execution of applications on wireless computing devices.

Processor 22 includes various processing subsystems 42 embodied in hardware, firmware, software, and combinations thereof, that enable the functionality of communication device 10 and the operability of the communication device on a wireless network. For example, processing subsystems 42 allow for initiating and maintaining communications, and exchanging data, with other networked devices. In aspects in which the communication device is defined as a cellular telephone the communications processor 22 may additionally include one or a combination of processing subsystems 42, such as: sound, non-volatile memory, file system, transmit, receive, searcher, layer 1, layer 2, layer 3, main control, remote procedure, handset, power management, digital signal processor, messaging, call manager, Bluetooth® system, Bluetooth® LPOS, position engine, user interface, sleep, data services, security, authentication, USIM/SIM, voice services, graphics, USB, multimedia such as MPEG, GPRS, etc (all of which are not individually depicted in FIG. 2 for the sake of clarity). For the disclosed aspects, processing subsystems 42 of processor 22 may include any subsystem components that interact with the location determination module 30.

Computer platform 20 additionally includes communications module 26 embodied in hardware, firmware, software, and combinations thereof, that enables communications among the various components of the wireless communication device 10, as well as between the communication device 10 and wireless network 16. In described aspects, the communication module 26 enables the communication of all correspondence between wireless communication device 10, the location satellites 14 (shown in FIG. 1) and the PDE 18 (shown in FIG. 1). Thus, communication module 26 may include the requisite hardware, firmware, software and/or combinations thereof for establishing a wireless network communication connection and for receiving satellite signals. In some aspects, the communication module may be operable to receive location determination request 28 communicated from a wireless network device and/or a network entity and to internally communicate the location determination request 26 to the location determination module 30.

The memory 24 of computer platform 20 may include one or more applications 44 operable to generate location determination request 26. Applications 44 may include a mapping and/or navigation application that allows a user to track their location in relation to a map or a desired destination, a performance diagnostic application that associates a location with a performance event, such as a call drop, a call failure, a call success, an Out-Of-Service (OOS) event or the like, and any other application that may utilize location information. It should be noted that for certain applications, for example a performance diagnostic application, location determination may occur in the background while other applications or features on the device are executing. For example, voice calls or data sessions (e.g. Internet sessions, Short Message Service (SMS) communication) may transpire while location determination attempts are being made.

Additionally, wireless communication device 10 has input mechanism 72 for generating inputs into communication device, and output mechanism 74 for generating information for consumption by the user of the communication device. For example, input mechanism 72 may include a mechanism such as a key or keyboard, a mouse, a touch-screen display, a microphone, etc. In certain aspects, the input mechanisms 72 provides for user input to interface with an application, such application 44 to initiate a location determination request. Further, for example, output mechanism 74 may include a display, an audio speaker, a haptic feedback mechanism, etc. In the illustrated aspects, the output mechanism 108 may include a display operable to display an application interface for requesting location determination or a map that provides a determined device location.

Further, memory 24 of computer platform 20 includes location determination module 30 that is operable to attempt location determination for the wireless device 10 based on received location determination request 26. For example, location determination module 30 may include the gpsOne™ position-location technology available from Qualcomm Incorporated of San Diego, Calif. Further, location determination module 30 includes at least one mode-selection routine 32 that is operable identify at least one location determination mode 34, for example on a per location request basis. Mode-selection routine 32 may include an algorithm, a heuristic, a neural network, fuzzy logic, and/or any other code executable by processor 22 in order to identify and/or execute one or more location determination modes 34. For example, mode-selection routine 32 may be configured to optimize one or more predetermined factors associated with location determination, such as likelihood of success of a given mode, availability of resources (e.g., network communication, assistance information, etc.) to execute a given mode, availability of a given mode on the respective wireless device, past performance of a given mode, affect on other wireless device-based services such as a currently executing voice call, data call, application, etc. As such, mode-selection routine 32 may select from among a plurality of modes, and/or may select whether or not to execute an available mode, depending on its configuration.

As noted above, location determination modes 34 may include both GPS-based modes and network-based modes, and combinations of both. For example, location determination modes 34 include, but are not limited to, MS-Based mode 48, MS-Assisted mode 50, Standalone mode 52 and any other known or future known location determination mode 54. For example, other location determination mode 54 may include modes such as cell identification, enhanced cell identification, time of arrival, angle of arrival, enhanced observed time difference (E-OTD), cell broadcast, cell-based position, Advanced Forward Link Trilateration (AFLT).

For example, in some aspects, the MS-based mode 48 of location determination is characterized in that calculation of the device location occurs at the wireless device using a location determination function 65. While MS-based mode 48 may utilize PDE assistance information 56, such as ephemeris data 58 and/or almanac data 60, to assist in obtaining GPS signals, each location determination attempt may not include communication with the PDE 18 if the PDE assistance information 56 is current enough to determine location. For example, in some aspects, during the very first MS-based attempt, the location determination module 30 will download ephemeris data 58 and almanac data 60. It should be noted, however, that this information may be acquired in other manners. Thereafter, location determination module 30 may perform an ephemeris check to look at the almanac data 60 to see if there are any satellites recently risen, and will request new or updated ephemeris data 58, if necessary, based on the number of satellites in view for which it already has fresh ephemeris data 60. For example, depending on the size of the satellite network, an ephemeris check may result in a request to update PDE assistance information 56 occurring every 30 to 90 minutes. When the wireless device updates the PDE assistance information 56, then the wireless device communicates through a communication link via the wireless network with the PDE 18 to obtain current ephemeris data 58 and/or almanac data 60. Once the wireless device has verified or obtained PDE assistance information 56, the wireless device uses the PDE assistance information 56 to set the parameters for receiving the GPS signals, and subsequently receives the timing signals broadcasted from the GPS satellites. Once the GPS signals are received, the wireless device decodes the signals using the PDE assistance information 56 to aid in setting the decode parameters. The wireless device then uses the decoded timing information and executes a location determination function 65 to determine device location 36.

More specifically, in another example, MS-based mode 48 with the gpsOne™ solution is an Assisted-GPS implementation with some hybrid capabilities. In this mode, the wireless device does not directly utilize CDMA pilot phase measurements (PPM) in positioning calculations, thereby limiting indoor positioning capability to areas where sufficient GPS signals can be detected. However, the gpsOne™ MS-based mode is able to utilize some local network parameters to enhance satellite acquisition times and device sensitivity, enabling enhanced time to fix and availability versus typical standalone GPS solutions.

MS-Assisted mode 50 location determination is characterized in that calculation of the device location occurs at the PDE 18 and, as such, communication with the PDE 18 occurs for each location determination attempt that uses MS-Assisted mode. If the wireless device chooses to update the PDE assistance information 56, the wireless device communicates through the wireless network with the PDE 18 to obtain current ephemeris data and/or almanac data. Once the wireless device has verified or obtained PDE assistance information 56, the wireless device uses the PDE assistance information 56 to set the parameters for receiving the GPS signals and, subsequently receives the timing signals broadcasted from the GPS satellites. Once the GPS signals are received, the wireless device decodes the signals using the PDE assistance information 56 to aid in setting the decode parameters. The wireless device uses the decoded timing information to make measurements related to the distance from the GPS satellites and the wireless device communicates the measurement information to the PDE. The PDE 18 uses the measurement information and executes a location determining function 65 to determine the location of the wireless device. Thus, for MS-Assisted mode 50 a wireless network signal or communication link is needed as the MS-Assisted mode 50 utilizes communication with the PDE 18.

More specifically, in another example, MS-assisted mode 50 with the gpsOne™ solution uses the wireless device to collect satellite data as well as CDMA pilot phase measurements (PPM). This information is used by the PDE to calculate the location of the wireless device. The wireless device essentially acts as a sensor to enable position calculation on the PDE. In turn, the PDE provides both sensitivity and acquisition assistance information that greatly enhances GPS sensitivity, system availability, terrain coverage, and accuracy as well as performing the positioning calculations to provide a location, also referred to as a fix. By utilizing PDE assistance information, the MS-Assisted mode solution provides the highest level of GPS sensitivity and accuracy while essentially eliminating cold start time. The concurrent use of CDMA-based pilot information enables deep indoor location capability in addition to enhancing AGPS performance.

Standalone mode 52 is characterized in that calculation of the device location occurs at the wireless device and without communication with PDE 18. However, standalone mode 52 is generally the most processing intensive location determination mode as compared to the MS-based, MS-assisted and network-based modes, and thus the Standalone mode utilizes the most battery power. The standalone GPS mode of operation may be utilized when the wireless device is out of cellular coverage, when the wireless device does not have access to a PDE, or when minimizing data transactions is desired. Typical examples of such areas are in boating or outdoors/hiking/camping environments where navigation and/or positioning may be useful even in the absence of a communications link, or alternatively, in areas of coverage for high-use applications such as fleet management. In standalone mode, the wireless device receives timing signals broadcasted from GPS satellites. The wireless device uses the timing signals and executes a position determining function 65 to determine a device location.

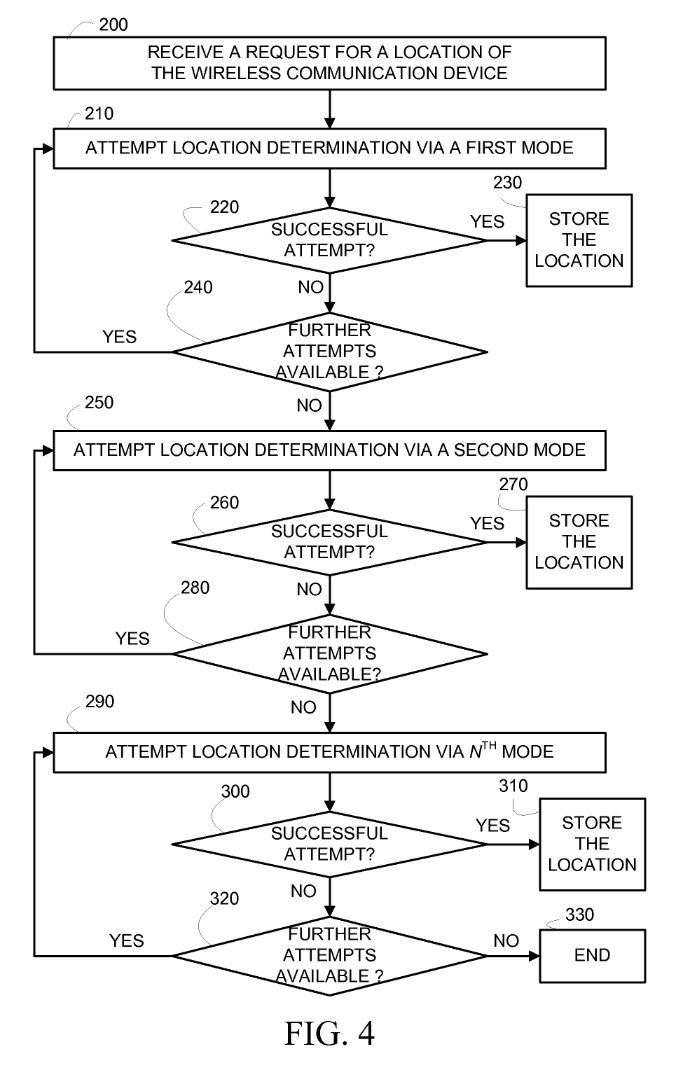

In some aspects, mode-selection routine 32 may be configured to sequence through multiple trials trying to successfully determine a location 36. In addition, mode-selection routine 32 may be configured to provide for multiple attempts within a given trial before the routine abandons the trial and moves to the next trial in the sequence. FIG. 4, which will be described in length infra., provides for a mode selection method based on sequencing through trials and attempting multiple location determination attempts within a given trial. Sequencing through multiple trials and allowing for multiple attempts within a given trial allows for mode-selection routine 32 to prioritize modes based on the effectiveness, efficiency, past performance and battery power usage of the various sequenced modes. For example, in some mode-selection routines 32, MS-Based mode 48 may be the first mode in the sequence because it affords relatively high probability of success, only utilizes wireless communication with the PDE if the PDE assistance information 56 requires updating, and limits the use of battery power. Conversely, in some routines 32, Standalone mode 52 may be the last mode in the sequence and may be limited to one attempt because it utilizes a high amount of battery power.

In other aspects, mode-selection routine 32 may be configured to determine one or more existing conditions that affect location determination and/or that affect device performance, and then identify and/or select a mode based on the determined existing conditions. Examples of existing conditions include, but are not limited to, current wireless signal state, such as Code Division Multiple Access (CDMA) signal state or Global System for Mobile (GSM) communications signal state, Universal Mobile Telecommunications System (UMTS) signal state, Wireless Fidelity (Wi-Fi) signal state, Worldwide Interoperability for Microwave Access (WiMAX) signal state, current state of information communicated from the PDE, such as ephemeris data, almanac data and the like, current communications state, such as voice call state, data session state or the like, current battery power state, current environmental condition(s) state, such as visibility or received signal strength of the GPS satellites, and any other existing conditions which may affect location determination.

Thus, mode-selection routine 32 may communicate with wireless signal monitor 62 to determine the current state of the wireless signal, e.g. to determine if a communication link with wireless network is and/or can be established and maintained. Further, mode-selection routine 32 may communicate with voice call module 64 to determine if a voice call is currently active, and with data call module 66 to determine if a data session is currently active. Additionally, mode-selection routine 32 may communicate with PDE assistance information 56 to determine the age or currency of PDE assistance information, such as ephemeris data 58 and almanac data 60. Additionally, mode-selection routine 32 may communicate with battery monitor 68 to determine the current battery power level. Further, mode-selection routine 32 may communicate with other environmental condition modules 70 to determine other environmental conditions that affect location determination and/or device performance.

It should be noted that while location determination module 30 and its components, as well as wireless signal monitor 62, voice call module 64, data call module 66 and battery monitor 68 are illustrated in wireless device 10 of FIG. 2 as modules and monitors residing in memory 24, in other aspects any or all of these modules and monitors may exist as other architectural components of wireless device 10, such as in processing subsystems 42 of processor 22.

In addition to choosing a location determination mode based on the existing conditions, the determined existing conditions may be used in mode-selection routine 32 to suspend or cancel the execution of the respective location determination mode. For example, certain conditions, such as a voice call or data call occurring while a location attempt is being made, may adversely affect the performance of the voice call or data call. In some aspects, rather than diminishing the experience of the device user by adversely affecting the voice call or data call, mode-selection routine 32 may be configured to delay the routine for a predetermined period of time or until the voice call or data call is ended, or the mode-selection routine 32 may be configured to cancel execution of location determination.

In instances in which mode-selection routine 32 is configured to determine more than one existing condition and select a mode based on the more than one existing condition, the selection of the mode may be based on prioritizing the plurality of conditions and/or modes, weighting the plurality of conditions and/or modes, and/or implementing any other logical decision making process to rank or emphasize one condition or mode with respect to another so that a mode may be selected.

In some aspects, mode-selection routine 32 may be configured to determine one or more existing conditions and further determine whether an available mode may be attempted based on the existing conditions. For example, in one aspect, a wireless device may be limited to one location determination mode. In this aspect, one or more existing conditions may be determined and, subsequently, a decision is made as to whether to proceed with an attempt of the location determination mode based on the existing conditions. For example, if the wireless device is limited to MS-assisted mode location determination and one of the existing conditions is the state of a wireless signal or communication link, a determination that the wireless signal or communication link is not currently available will result in no attempt being made to use MS-assisted mode to determine location.

Further, in some aspects, mode-selection routine 32 may be configured to determine one or more existing conditions and, based on the existing conditions, determine which mode is the best mode for location determination or to determine the best sequence of modes or a prioritized list of modes to use for location determination. It should be noted that the best mode may be defined in terms of the mode that may yield the highest likelihood of a successful location determination, or the mode that uses the least amount of device resources, or the mode that properly balances the likelihood of success and limits the use of device resources, or the mode having the least impact on other wireless device services.

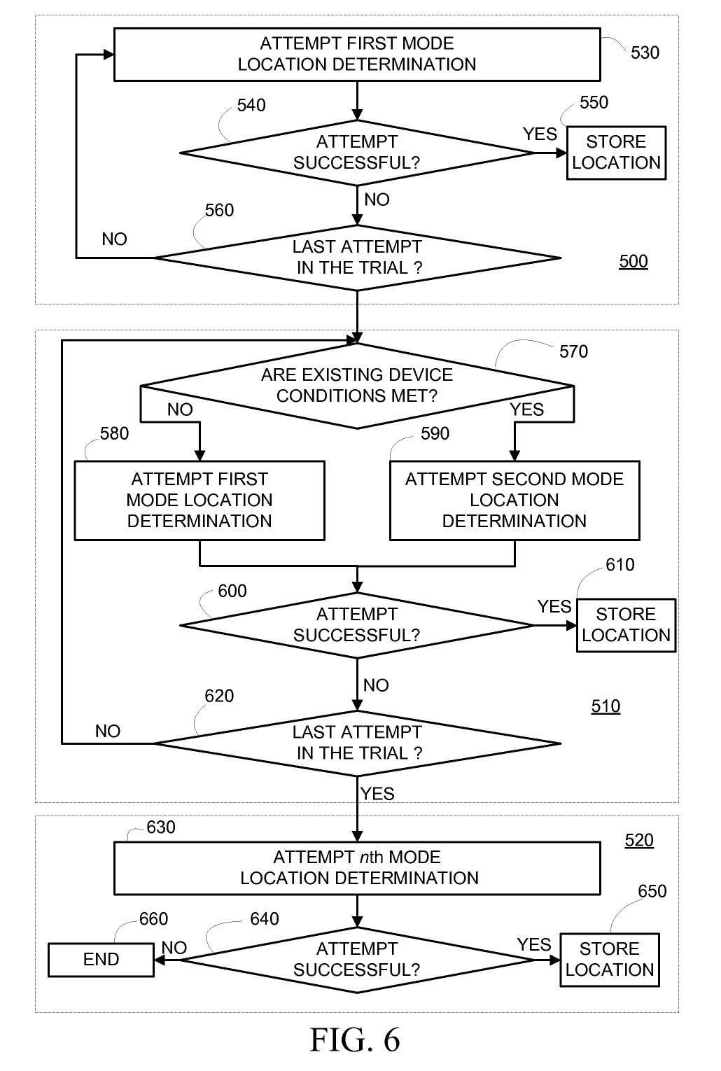

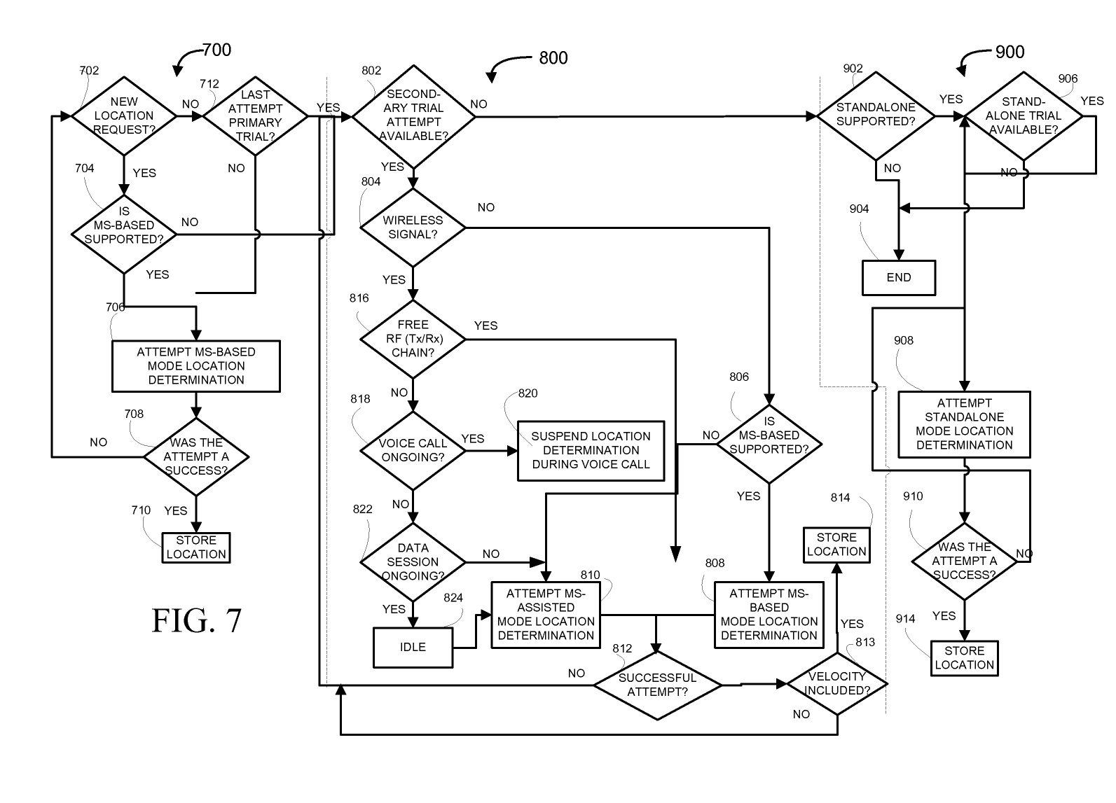

In particular, as illustrated in the methods discussed below in relation to FIGS. 6 and 7, in some aspects, mode-selection routine 32 may provide for sequencing through multiple trials, allowing for multiple attempts within a given trial and determining, within one or within a predetermined sequence of trials, one or more existing conditions that affect location determination.

Thus, wireless device 10 includes the modules and logic operable, in response to a location determination request, to determine a location determination mode based on a mode-selection routine, attempt location determination, and save the determined location if the attempt is successful and save an indicator indicating an unsuccessful attempt if the attempt is unsuccessful

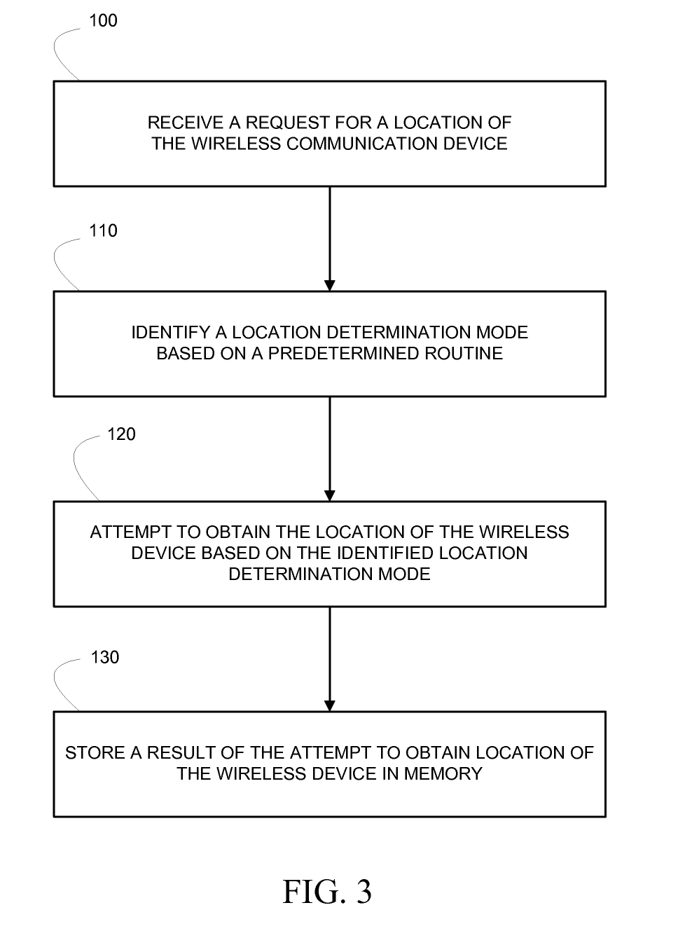

Referring to FIG. 3, a flow diagram is presented of a method for determining the location of a wireless communication device. At Event 100, a request for location determination is received. The request may be an internal request received from an application that utilizes location determination, such as a mapping or navigation application, a performance diagnostic application or the like, or the request may be an external requested received wirelessly from a network device or entity.

At Event 110, at least one location determination mode is identified, in response to the location determination request, based on a mode-selection routine. It should be noted that in some instances, the wireless device may only have one available location determination mode, in which case the only available mode will be identified mode as determined by the mode-selection routine. As previously noted, in some aspects, identifying a location determination mode may include sequencing through multiple trials and allowing for multiple location determination attempts within a given trial, and/or determining one or more existing conditions that affect location determination and selecting a mode based on the determined existing conditions. In one specific aspect in which the wireless device has only one available location determination mode, the mode-selection routine may determine existing conditions and, based on the existing conditions, a determination may be made as to whether to attempt the available mode. In other aspects, the mode-selection routine may determine existing conditions and, based on the existing conditions, determine the best mode or rank or prioritize modes from among a plurality of location determination modes or determine a best sequence for executing the modes.

At Event 120, the identified mode is executed in an attempt to obtain the location of the wireless communication device. In some aspects, the selected mode may be attempted numerous times until a successful location determination results. In other aspects, such as when mode sequencing is implemented, multiple modes may be selected and executed in a predetermined order until a successful location determination results. It should also be noted that in some instances, execution of the selected mode or selected modes may result in a failure to determine a location. In certain instances, in which specific conditions exist, failure to determine a location may be an acceptable result of the location determination process to insure the integrity of other device functions, such as voice call or data call quality, the uninterrupted execution of another application on the device, battery power level and the like.

At Event 130, the result of the attempt to obtain location of the wireless device is stored in memory. Storing the result of the attempt to obtain location in memory may involve returning the location to the internal application that requested location determination and storing the location within the application or storing the result of the attempt to obtain location in memory may involve communicating the location to the network device/entity that requested location determination and, subsequently, remotely storing the location in a network database.

Referring now to FIG. 4, one aspect of a method for location determination includes the mode-selection routine operating to identify and execute the mode based on sequencing through multiple trials and allowing for multiple attempts within a given trial. At Event 200, a request for location determination is received. As previously noted, the request may be an internal request received from an application or the request may be an external requested received from a network device/entity.

At Event 210, an attempt is made to determine location using a first location determination mode. The first location determination mode is the first mode in a sequence of modes and defines the first trial. The sequence order may be determined based on various factors that affect the efficiency and effectiveness of the location determination process, as well as the effectiveness of other applications and features being executed on the wireless device.

At Event 220, a determination is made as to whether the attempt was successful in determining the location of the device. If the attempt to determine location was successful then, at Event 230, the location is stored, either in an internal memory or in an external memory, such as on a remote or disconnectable device. If the attempt to determine location was not successful then, at Event 240, a determination is made as whether additional attempts are to be executed for the first trial. In this regard, the mode-selection routine may be configured to provide for more than one attempt for a given trial. For example, the mode-selection routine may be configured to provide for a predetermined number of attempts using the first location determination mode before sequencing to the second location determination mode. If additional attempts are available for the first trial, then the routine will return to Event 210 and an additional attempt is made using the first location determination mode.

If no further attempts are available for the first trial then, at Event 250, the routine will sequence to the second location determination mode and an attempt is made to determine location using the second location determination mode.

At Event 260, a determination is made as to whether the attempt was successful in determining the location of the device. If the attempt to determine location was successful then, at Event 270, the location is stored in the manner noted above. If the attempt to determine location was not successful, then, at Event 280, a determination is made as whether additional attempts are to be executed for the second trial. If additional attempts are available for the second trial, the routine will return to Event 250 and an additional attempt is made using the second trial.

The sequencing through trials to successfully determine a location continues until the last trial in the sequence is encountered. In the illustrated aspect of FIG. 4, the last trial in the sequence is the nth trial as defined by the nth location determination mode, where n is a positive integer. The nth trial may be the second trial in the sequence or any subsequent trial in the sequence. Continuing with the above description of the method, if no further attempts are available for the second trial, then, at Event 290, the routine will sequence to the nth trial and an attempt is made to determine location using the nth location determination mode. At Event 300, a determination is made as to whether the attempt was successful in determining the location of the device. If the attempt to determine location was successful, then, at Event 310, the location is stored. If the attempt to determine location was not successful, then, at Event 320, a determination is made as whether additional attempts are to be executed for the nth trial. If further attempts are available for the nth trial, then the routine returns to Event 290 and an additional attempt is made using the nth mode. If no further attempts are available, then, at Event 330, the location determination process ends, in this instance, without having successfully determined a location.

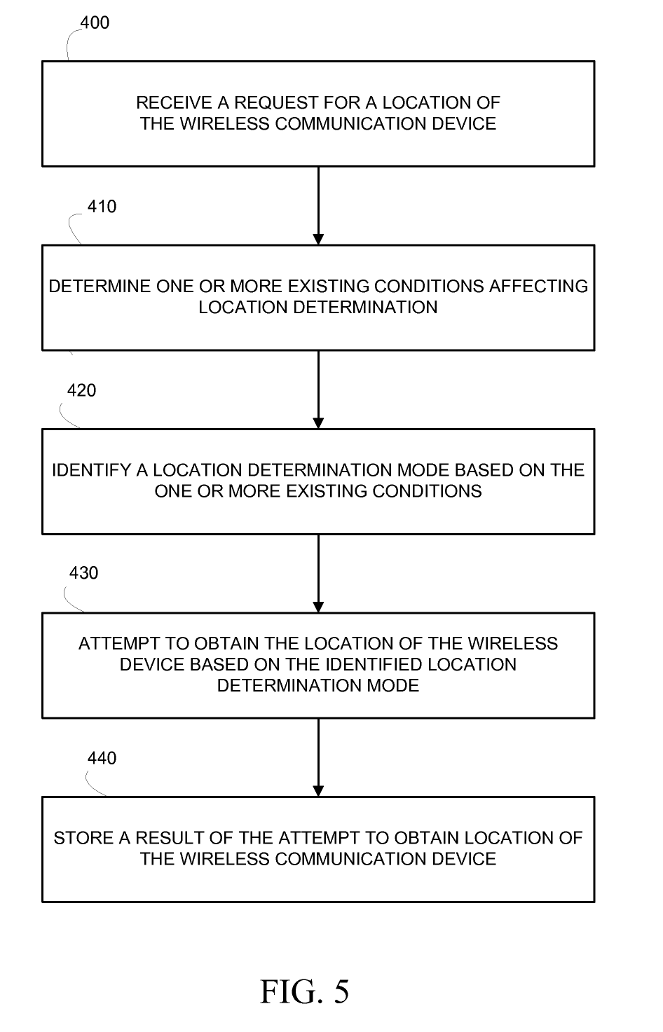

Referring to FIG. 5, one aspect of a method for location determination includes the mode-selection routine operating to determine existing conditions that affect location determination, and selecting the mode based on the determined existing conditions. At Event 400, a request for location determination is received. As previously noted, the request may be an internal request received from an application, or the request may be an external requested received from a network device/entity.

At Event 410, in response to the received location determination request, the wireless device determines one or more existing conditions affecting location determination. For example, the existing conditions may be predetermined and included as part of mode-selection routine 32. Examples of existing conditions include, but are not limited to, current wireless signal state, such as Code Division Multiple Access (CDMA) signal state or Global System for Mobile (GSM) communications signal state, Universal Mobile Telecommunications System (UMTS) signal state, Wireless Fidelity (Wi-Fi) signal state, Worldwide Interoperability for Microwave Access (WiMAX) signal state, current state of information communicated from the PDE, such as ephemeris data, almanac data and the like, current communications state, such as voice call state, data session state or the like, current battery power state, current environmental condition(s) state, such as visibility or received signal strength of the GPS satellites, and any other existing conditions which may affect location determination.

At Event 420, a location determination mode is identified based on the one or more existing conditions. For example, if the existing condition is defined as the current state of the wireless signal or wireless communication link, then the routine may choose to apply the MS-Based mode if no wireless signal or wireless communication link is currently available, or the routine may choose the MS-Assisted mode if a wireless signal or wireless communication link is available. In instances in which more than one existing condition is determined and used in the selection of a mode, each of the conditions and/or each of the modes may be prioritized, weighted and/or otherwise ranked with respect to one another. For example, each of the plurality of conditions may be weighted based on significance of the condition with respect to likelihood of success of a given location determination mode. Further, for example, an appropriate weighted algorithm or any other decision-making mechanism may be applied to select a mode based on the plurality of conditions. In addition to selecting a mode based on existing conditions, the method may also provide for suspending or canceling the implementation of a mode based on an existing condition. For example, if the condition is defined as the current state of a voice or data call, the routine may be configured to delay or cancel the execution of the location determination mode and/or the routine.

In one specific aspect in which the wireless device has only one available location determination mode, the mode-selection routine may determine existing conditions and, based on the existing conditions, a determination may be made as to whether to attempt the available mode. In other aspects, the mode-selection routine may determine existing conditions and, based on the existing conditions, determine the best mode from among a plurality of available location determination modes or determine a best sequence for the modes.

At Event 430, the identified mode is executed in an attempt to obtain the location of the wireless communication device. As previously noted, in some instances, execution of the selected mode or selected modes may result in a failure to determine a location.

At Event 430, the result of the attempt to determine location of the wireless device is stored in memory. As previously noted, storing the result of the attempt to determine location in memory may involve returning the location to the internal application that requested the location storing the location internally or storing the result of the attempt to determine location in memory may involve communicating the location to the network device/entity that requested location determination and, subsequently, remotely storing the location in a network database.

Referring to FIG. 6, one aspect of a specific method for location determination includes the mode-selection routine operating to sequence through multiple mode trials, where one or more of the trials include a determination of existing conditions. The illustrated aspect provides for three mode trials for location determination, however, it should be noted that n trials may be utilized. The first trial 500 selects a first location determination mode and may attempt the trial more than one time before moving to the second trial. The second trial 510 selects either the first or second location determination mode based on the determined existing condition(s) and may attempt the trial more than one time before moving to the third or nth trial. The nth trial 520 selects an nth location determination mode and attempts the mode one time, if the attempt of the nth mode is not successful the routine is ended and no location determination results.

At Event 530, an attempt is made to determine location using a first location determination mode. At Event 540, a determination is made as to whether the attempt was successful in determining the location of the device. If the attempt to determine location was successful then, at Event 550, the location is stored, either in an internal database or in an external database, such as network database. If the attempt to determine location was not successful then, at Event 560, a determination is made as whether additional attempts are available for the first trial. In this regard, the mode-selection routine may be configured to provide for more than one attempt for a specified trial. If additional attempts are available for the first trial, the routine will return to Event 530 and an additional attempt is made using the first location determination mode.

If no further attempts are available for the first trial then, at Event 570, the routine will sequence to the second trial 510 and a determination is made as to whether existing conditions that affect location determination are met. For example, the defined existing condition may be the current state of the wireless signal or any other condition that affects location determination. If the conditions are not met, at Event 580, an attempt is made to determine location using the first location determination mode. It should be noted that use of the first mode is not required; any other available mode may be used if the existing conditions are not met. If the existing conditions are met then, at Event 590, an attempt is made to determine location using a second location determination mode.

At Event 600, a determination is made as to whether the attempt was successful in determining the location of the device. If the attempt to determine location was successful then, at Event 610, the location is stored, either in an internal database or in an external database, such as network database. If the attempt to determine location was not successful then, at Event 620, a determination is made as whether additional attempts are available for the second trial. If additional attempts are available for the second trial, the routine will return to Event 570 and determine if existing conditions are met prior to choosing the mode that will be used to attempt to determine location.

If no further trials are available for the second trial then, at Event 630, the routine will sequence to the nth trial 520 and an attempt is made to determine location using the a nth mode. At Event 640, a determination is made as to whether the attempt was successful in determining the location of the device. If the attempt to determine location was successful then, at Event 650, the location is stored, either in an internal database or in an external database, such as network database. If the attempt to determine location was not successful then, at Event 660, the location determination process ends, in this instance, without having successfully determined a location. As previously noted, the nth trial 520 in the illustrated aspect of FIG. 6 is configured to only provide for one attempt of the nth location determination mode.

Referring now to FIG. 7, one aspect of a specific method for location determination includes the mode-selection routine operating to sequence through three trials, attempting location determination within a given trial multiple times, determining existing conditions within the second trial and selecting the next mode to execute based on the determined existing conditions. The illustrated aspect provides for three trials for mode selection, however, n trials may be utilized. In this case, the three trial modes, as well as their relative sequencing, are predetermined in order to minimize device resource usage and in order to minimize interruption of, or degradation in quality of, use of other services, such as a voice call, on the device.

Further, although described as sequencing through three trials, in this aspect, mode-selection routine may also be described as choosing from among a first set of location determination modes based on a first set of conditions. Then depending on the outcome, chooses from a second set of location determination modes based on a second set of conditions different from the first set of conditions, and so on. As such, each sequence in the operation may be associated with a sequence-specific set of modes and/or a sequence-specific set of conditions that are used to determine which one of the respective modes to select. It should be understood that the set of location determination modes, and the sets of conditions, for each routine and/or each sequence in the routine may be the same or may vary, depending on the specific goals of a given implementation of the mode-selection routine.

The first trial 700 utilizes MS-Based mode and may attempt more than one location determination attempts before moving to the second trial. The second trial 800 selects either the MS-Based or MS-Assisted mode based on the current wireless service state and may attempt the more than one location determination attempt before moving to the third or nth trial. The third trial 900 selects the Standalone mode and attempts the mode a predetermined number of times, if all attempts of the Standalone mode are not successful the routine is ended and no location determination results.

At Event 702, a determination is made as whether this is a new request for a location determination, otherwise referred to as a GPS fix. If it is determined that this is a new request for a location then, at 704, a determination is made as to whether MS-Based mode location determination is supported by the wireless device. If MS-Based mode location determination is not supported the routine will skip the first trial 700 and immediately move to the second trial 800. If MS-Based mode location determination is supported by the wireless device, then, at Event 706, an attempt is made to determine location using the MS-Based mode of location determination. At Event 708, a determination is made as to whether the attempt was successful in determining a location. If the attempt was successful, then, at Event 710, the location is stored in local or remote memory.

If the attempt was not successful, then the routine will return to Event 702 to determine whether the request for location is a new request. If the request is not a new request then, at Event 712, a determination is made as to whether the previous attempt was the last attempt as configured by the trial. The trial may be configured to allow for one or more attempts to determine location under the trial. If the determination is made that the previous attempt was not the last attempt as configured by the trial then, at Event 706, another attempt is made to determine location using the MS-Based mode of location determination and, at Event 708, a subsequent determination is made to determine if the attempt was successful. If the attempt was successful, at Event 710, the location is stored or, if the attempt was not successful the routine returns to Events 704 where a determination is made as to whether the previous attempt was the last attempt as configured by the trial. Once the last attempt in the trial is unsuccessfully attempted, the first trial 700 is ended and the routine moves to the second trial 800.

At Event 802, a determination is made as to whether an attempt is available for the second trial. Similar to the first trial, the second trial may be configured to allow for multiple attempts to obtain a location using the second trial. If an attempt is available the, at Event 804, a determination of an existing condition occurs. Specifically, at Event 804, a determination is made as to whether a wireless signal is currently available. If no wireless signal is available the, at Event 806, a determination is made as to whether MS-Based mode location determination is supported by the wireless device. If MS-Based mode location determination is supported then, at Event 808, an attempt is made to determine location using the MS-Based mode of location determination. If MS-Based mode location determination is not supported then, at Event 810, an attempt is made to determine location using the MS-Assisted mode of location determination. As previously discussed, MS-Assisted mode utilizes a wireless signal in order to communicate with the PDE because in MS-Assisted mode the location calculation is accomplished at the PDE. Thus, in order for this attempt to succeed, the wireless signal must have become available since the determination was made at Event 804. Once the attempt for location determination has occurred (at either Event 808 or 810), at Event 812 a determination is made as to whether the attempt was successful. If the attempt was unsuccessful in determining a location, then the routine returns to Event 802, to determine if an additional attempt is available for the second trial. If the Attempt was successful, then, at Event 813, a velocity check is made to determine if the location determination includes a velocity parameter. If the location determination includes a velocity parameter, then, at Event 814, the location is stored in internal or external memory. If the velocity check determines that the location determination does not include a velocity parameter, then the routine returns to Event 802 to determine if an additional attempt is available for the second trial.

If at Event 804, a determination is made that a wireless signal is available, then, at Event 816, a determination is made as whether a Radio Frequency (RF) Transmit/Receive (Tx/Rx) chain, e.g. a wireless communication link, is currently available. If an RF Tx/Rx chain is available, then, at Event 810, an attempt is made to determine location using MS-Assisted mode location determination. If an RF Tx/Rx chain is not available, then, at Event 818, a determination is made as to whether a voice call is currently ongoing. If a voice call is ongoing, then, at Event 820, location determination is suspended for a predetermined amount of time or until notification of a predetermined event such as the end of the call. Typically, attempting location determination during a voice call will detrimentally affect the quality of the voice call and, therefore, the location determination process is suspended so as to not adversely affect the user's voice call experience. If a determination is made that no voice call is currently ongoing, then, at Event 822, a determination is made as to whether a data call/session is currently ongoing. If no data session is ongoing, then, at Event 810, an attempt is made to determine location using MS-Assisted mode location determination. If a data call/session is ongoing, then, at Event 824, the routine idles for a predetermined time period or until notification of the end of the call in attempt to try and wait to attempt the location determination after the data session has ended. After the predetermined idle period, at Event 810, an attempt is made to determine location using MS-Assisted mode location determination. Once the MS-assisted mode is attempted, at Event 812, a determination is made as to whether the attempt was successful. If the attempt was successful, then, at Event 814, the location is stored in internal or external memory. If the attempt was unsuccessful in determining a location, then the routine returns to Event 802 to determine if an additional attempt is to be executed for the second trial. If no further attempts are available for the second trial, the second trial is ended and the routine moves to the third trial 900.

At Event 902, a determination is made as to whether standalone mode is supported by the wireless device. If standalone mode is not supported, at Event 904, the routine is ended without having successfully determined a location. If standalone mode is mode is supported, then, at Event 906, a determination is made as to whether a standalone trial attempt is available. If no standalone trial attempt is available, then, at Event 904, the routine is ended without having successfully determined a location. If a standalone mode attempt is available, then, at Event 908, an attempt is made to determine location using Standalone mode location determination. Once the Standalone mode is attempted, at Event 910, a determination is made as to whether the attempt was successful. If the attempt is unsuccessful, then the routine returns to Event 906 and a determination is made as to whether an additional standalone mode attempt is available. If the attempt was successful, then, at Event 914, the location is stored in internal or external memory.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes or instructions on a machine-readable medium and/or computer readable medium, such as may be provided by a computer program product. Further, the steps and/or actions of a method or algorithm may be implemented in one or more modules of a processor.

While the foregoing disclosure shows illustrative aspects and/or embodiments, it should be noted that various changes and modifications could be made herein without departing from the scope of the described aspects and/or embodiments as defined by the appended claims. Furthermore, although elements of the described embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

Thus, present aspects provide for methods, devices, systems and computer program products for present aspects provide for methods, systems, devices and computer program products that improve the ability of the wireless device to determine location. Present aspects provide for identifying a location determination mode based on a mode-selection routine for each location determination that is requested. In this regard, present aspects provide greater flexibility in the selection of the location determination mode, do not limit the mode selection to an application-basis or an application initialization-basis and, as such, present aspects significantly decrease location determination failure rates in wireless communication devices.

Many modifications and other aspects will come to mind to one skilled in the art to which this invention pertains having the benefit of the teachings presented in the foregoing descriptions and the associated drawings. Therefore, it is to be understood that the aspect is not to be limited to the specific aspects disclosed and that modifications and other aspects are intended to be included within the scope of the appended claims. Although specific terms are employed herein, they are used in a generic and descriptive sense only and not for purposes of limitation. Accordingly, the described aspects are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method for location determination in a wireless communication device, comprising:
receiving a request for a location of the wireless communication device;
identifying at least one location determination mode based on execution of a mode-selection routine in response to the received request;
attempting to obtain the location of the wireless communication device based on the identified location determination mode; and
storing a result of the attempt to obtain the location in memory.

2. The method of claim 1, wherein identifying at least one location determination mode further comprises identifying a predetermined sequence of more than one location determination mode, and wherein attempting to obtain the location of the wireless communication device further comprises executing the predetermined sequence of more than one location determination mode until a location of the wireless communication device is determined or until the end of the predetermined sequence is reached.

3. The method of claim 2, wherein executing the predetermined sequence further comprises executing a predetermined number of location determination attempts within each one of the predetermined sequence of more than one location determination mode until a location of the wireless communication device is determined or until the predetermined number is reached.

4. The method of claim 2, wherein executing the predetermined sequence further comprises attempting Mobile Station Based (MS-Based) mode location determination, and if unsuccessful in determining the location, then attempting Mobile Station-Assisted (MS-Assisted) mode location, and if unsuccessful in determining the location, then attempting Standalone Mode location determination.

5. The method of claim 1, wherein identifying at least one location determination mode further comprises determining one or more existing conditions affecting a location determination mode and selecting an available mode based on the existing conditions.

6. The method of claim 5, wherein determining one or more existing conditions affecting a location determination mode further comprises determining at least one of wireless signal state, voice call state, data call state, battery power state and assistance information state.

7. The method of claim 5, wherein determining one or more existing conditions affecting available location determination modes further comprises determining that a wireless communication signal is currently unavailable.

8. The method of claim 1, wherein identifying at least one location determination mode further comprises determining one or more existing conditions affecting a location determination mode and determining a sequence for the available modes based on the one or more existing conditions.

9. The method of claim 1, wherein identifying at least one location determination mode further comprises determining one or more existing conditions affecting available location determination modes and identifying an available mode if the one or more existing conditions provide for location determination using the available mode.

10. The method of claim 1, wherein identifying at least one location determination mode further comprises identifying a predetermined sequence of more than one location determination trials, wherein each trial provides for at least one location determination mode, and wherein attempting to obtain the location of the wireless device further comprises executing the predetermined sequence of more than one location determination trials until a location of the wireless communication device is determined or until the end of the predetermined sequence is reached.

11. The method of claim 10, wherein identifying a predetermined sequence of more than one location determination trials, wherein each trial provides for at least one location determination mode further comprises determining one or more existing conditions affecting a location determination mode for each trial and selecting an available mode based on the existing conditions.

12. The method of claim 1, wherein receiving a request for a location of the wireless communication device further comprises receiving the request from an application executable on the wireless device.

13. The method of claim 1, wherein receiving a request for a location of the wireless communication device further comprises receiving the request from a network entity.

14. The method of claim 1, wherein identifying at least one location determination mode further comprises identifying the at least one of Mobile Station-Based mode (MS-Based mode), Mobile Station-Assisted mode (MS-Assisted mode), Standalone Alone and a communication network-based mode.

15. At least one processor configured for location determination in a wireless communication device, comprising:
a first module for receiving a request for a location of the wireless communication device;
a second module for identifying at least one location determination mode based on execution of a mode-selection routine in response to the received request;
a third module for attempting to obtain the location of the wireless communication device based on the identified location determination mode; and
a fourth module for storing a result of the attempt to obtain the location in memory.

16. A computer program product, comprising:
a computer-readable medium comprising:
a first set of codes for causing a computer to receive a request for a location of the wireless communication device
a second set of codes for causing a computer to identify at least one location determination mode based on execution of a mode-selection routine in response to the received request;
a third set of codes for causing a computer to attempt to obtain the location of the wireless communication device based on the identified location determination mode; and
a fourth set of codes for causing the computer to store a result of the attempt to obtain the location in memory.

17. A wireless communication device, comprising:
means for receiving a request for a location of the wireless communication device;
means for identifying at least one location determination mode based on execution of a mode-selection routine in response to the received request;
means for attempting to obtain the location of the wireless communication device based on the identified location determination mode; and
means for storing a result of the attempt to obtain the location in memory.

18. A wireless communication device, comprising:
a computer platform including a processor and a memory; and
a location determination module stored in the memory, executable by the processor and including a mode-selection routine operable to identify at least one location determination mode in response to a received request for a location of the wireless communication device, wherein the location determination module is further operable to attempt to obtain the location based on the at least one identified location determination mode and store a result of the attempt in the memory.

19. The wireless communication device of claim 18, wherein the mode-selection routine is further operable to execute a sequence of location determined modes until the location of the wireless communication device is determined or until all modes in the sequence are executed.

20. The wireless communication device of claim 19, wherein the mode-selection routine is further operable to attempt a predetermined number of location determination attempts for each mode in the sequence until the location of the wireless communication device is determined or until the predetermined number is attempted.

21. The wireless communication device of claim 18, wherein the plurality of modes includes at least two of Mobile Station-Based mode (MS-Based mode), Mobile Station-Assisted mode (MS-Assisted mode), Standalone mode and a network-based mode.

22. The wireless communication device of claim 18, wherein the mode-selection routine is further operable to attempt MS-Based mode location determination and if unsuccessful in determining the location, attempt MS-Assisted mode location and if unsuccessful in determining the location, attempt Standalone Mode location determination.

23. The wireless communication device of claim 18, wherein the mode-selection routine is further operable to determine one or more existing conditions affecting a location determination mode and select an available mode based on the existing conditions.

24. The wireless communication device of claim 18, wherein the mode-selection routine is further operable to determine one or more existing conditions affecting a location determination mode and determine a sequence for the available modes based on the one or more existing conditions.

25. The wireless communication device of claim 23, wherein the one or more existing conditions are chosen from the group consisting of wireless signal state, voice call state, data call state, battery power state and assistance information state.

26. The wireless communication device of claim 18, wherein the mode-selection routine is further operable to determine that a wireless communication signal is currently unavailable and thereby identify the at least one location determination mode.

27. The wireless communication device of claim 18, wherein the mode-selection routine is further operable to determine one or more existing conditions affecting a location determination mode and identify an available location determination mode if the one or more existing conditions provide for executing the available location determination mode.

28. The wireless communication device of claim 18, wherein the mode selection routine is further operable to execute a predetermined sequence of more than one location determination trials, wherein each trial provides for at least one location determination mode, until a location of the wireless communication device is determined or until the end of the predetermined sequence is reached.

29. The wireless communication device of claim 28, wherein the mode selection routine is further operable to determine one or more existing conditions affecting a location determination mode for each trial and selecting an available mode based on the existing conditions.

30. The wireless communication device of claim 18, further comprising one or more applications that are operable to provide the request for the location of the wireless communication device, and wherein the location determination module is further operable to receive the request from the one or more applications.

31. The wireless communication device of claim 18, wherein the location determination module is further operable to receive the request from a network entity.
